(19) United States
(12) Patent Application Publication
(10) Pub. No.: US 2013/0006603 A1
(43) Pub. Date: Jan. 3, 2013

(54) GRAPHICAL USER INTERFACE LOCALIZATION SYSTEMS AND METHODS

(75) Inventors: Alex Zavatone, Irving, TX (US); Donald H. Relyea, Dallas, TX (US)

(73) Assignee: VERIZON PATENT AND LICENSING, INC., Basking Ridge, NJ (US)

(21) Appl. No.: 13/174,683

(22) Filed: Jun. 30, 2011

(51) Int. Cl. G06F 17/28

(52) U.S. Cl. 704/2

(57) ABSTRACT

An exemplary method includes a graphical user interface (“GUI”) localization subsystem identifying one or more text strings in a first spoken language included in a GUI design, generating a data structure containing data representative of the one or more text strings in the first spoken language, providing the data structure to a language translation subsystem for translation of the one or more text strings from the first spoken language to a second spoken language, receiving the data structure from the language translation subsystem, the received data structure containing data representative of the one or more text strings in the second spoken language, and generating, based on the received data structure and the GUI design, a localized version of the GUI design that includes the one or more text strings in the second spoken language. Corresponding methods and systems are also disclosed.

### BACKGROUND INFORMATION

Advances in computing technologies have led to a proliferation of computing devices in modern society. Myriad computing devices having various shapes, sizes, and capabilities have been made available to consumers. For example, consumers may choose from computing devices such as mobile phones, smart phones, tablet computers, e-reader devices, personal computers, media players, gaming devices, set-top-box (“STB”) devices, digital video recorder (“DVR”) devices, Global Positioning System (“GPS”) devices, and other types of computing devices.

The proliferation of computing devices in modern society has challenged designers and developers of graphical user interfaces (“GUIs”) for the computing devices. For example, the competitive landscapes between manufacturers of computing devices, between providers of applications that run on computing devices, and between providers of services accessed through the computing devices have pushed designers and developers of GUIs to design and develop GUIs as efficiently as possible without sacrificing quality.

Unfortunately, traditional processes for design and development of GUIs have not kept pace with the demands placed on the designers and developers of the GUIs. To illustrate, in a traditional design and development process, a designer utilizes a GUI design tool to design a screen layout of graphical elements to be included in a GUI. Once the design is complete, the designer provides information about the screen layout of graphical elements to a developer who is responsible for producing computing code configured to be executed by a computing device to render a GUI that includes the screen layout of graphical elements designed by the designer. This process is typically time consuming, requires significant manual labor by the designer and the developer, and is fraught with opportunities for error. For instance, the developer typically has to use the information provided by the designer to manually produce computing code for the screen layout. Moreover, the process must be repeated each time a modification is made to the screen layout, such as when text included in a screen layout is to be translated for localization of the GUI. “Localization” of a GUI refers to a process of adapting the GUI for a specific geographic region and/or spoken language by adding locale-specific components and/or translating text included in the GUI. Conventional processes for localizing GUIs into different spoken languages are time consuming, require significant manual labor, and/or are fraught with opportunities for error.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary GUI localization and export system according to principles described herein.

FIG. 2 illustrates a visual depiction of a GUI design according to principles described herein.

FIG. 3 illustrates exemplary components of a GUI localization and export subsystem according to principles described herein.

FIG. 4 illustrates an ordered list of layers associated with a GUI design according to principles described herein.

FIG. 5A illustrates an exemplary data structure containing an ordered list of text strings in a first spoken language according to principles described herein.

FIG. 5B illustrates an exemplary data structure containing an ordered list of text strings in a second spoken language according to principles described herein.

FIG. 6A illustrates exemplary GUI design data representing a GUI design in a first spoken language according to principles described herein.

FIG. 6B illustrates exemplary GUI design data representing a GUI design in a first spoken language and a localized GUI design in a second spoken language according to principles described herein.

FIG. 7 illustrates a visual depiction of a localized GUI design according to principles described herein.

FIG. 8 illustrates an exemplary proofing user interface according to principles described herein.

FIG. 9 illustrates an exemplary GUI localization and export method according to principles described herein.

FIG. 10 illustrates an exemplary computing device according to principles described herein.

### DETAILED DESCRIPTION OF PREFERRED EMBODIMENTS

Exemplary graphical user interface (“GUI”) localization and export systems and methods are described herein. In an exemplary method, a GUI localization and export subsystem may interface with a GUI design subsystem to access design data representative of a GUI design that includes one or more text strings in a first spoken language, identify, from the design data, the one or more text strings in the first spoken language included in the GUI design, generate a data structure containing data representative of the one or more text strings in the first spoken language, provide the data structure to a language translation subsystem for translation of the one or more text strings from the first spoken language to a second spoken language, receive the data structure from the language translation subsystem, the received data structure containing data representative of the one or more text strings in the second spoken language, and generate, from the received data structure and the design data representative of the GUI design, a localized version of the GUI design that includes the one or more text strings in the second spoken language.

This exemplary method and/or one or more other exemplary systems and methods disclosed herein may provide for automated, reliable, programmatic, and/or efficient design, development, and/or localization of a GUI. In some implementations, a timeline for design and development of localized GUI designs may be reduced significantly compared to typical timelines for design and development of localized GUI designs in accordance with conventional GUI design and development processes. Moreover, the opportunity for error may be reduced compared to the opportunities for error in conventional processes for design and development of localized GUIs.

These and/or other benefits provided by the disclosed exemplary systems and methods will be made apparent herein. Exemplary GUI localization and export systems and methods will now be described in reference to the accompanying drawings.

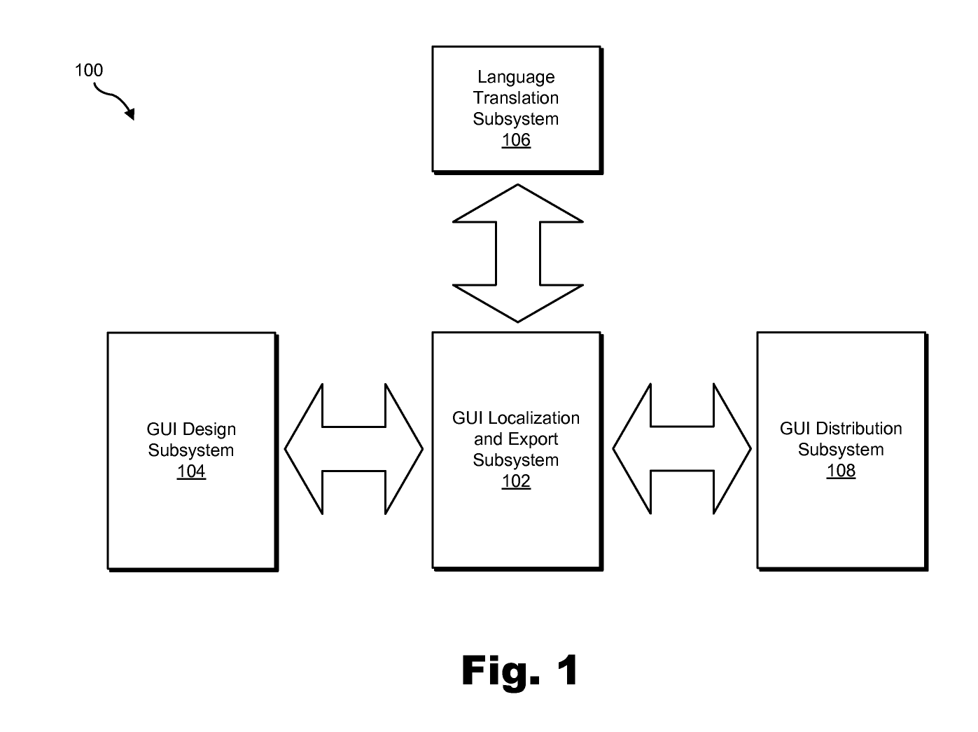

FIG. 1 illustrates an exemplary GUI localization and export system 100 (“system 100”). As shown in FIG. 1, system 100 may include a GUI localization and export subsystem 102 (“localization subsystem 102,” “export subsystem 102,” or “subsystem 102”), configured to communicate or otherwise interface with a GUI design subsystem 104 (“design subsystem 104”), a language translation subsystem 106 (“translation subsystem 106”), and a GUI distribution subsystem 108 (“distribution subsystem 108”). Any suitable communication technologies, including any of those disclosed herein, may be employed to support communications and/or interfaces between localization subsystem 102 and each of the other subsystems 104, 106, and 108. Each of the elements of system 100 will now be described in detail.

Design subsystem 104 may include or be implemented by one or more design tools with which a designer may interact to define a GUI design. In certain implementations, the tools may include one or more commercially available or proprietary GUI design software applications, such as Adobe Illustrator, Adobe Photoshop, and/or any other suitable GUI design software application(s).

Design subsystem 104 may be configured to provide a user interface through which a designer may interact with design subsystem 104 to define a GUI design. The user interface may be configured to visually depict the GUI design such that the designer may interact with the visual depiction to define and/or modify the GUI design.

Design subsystem 104 may be configured to maintain design data representative of a GUI design defined by a designer. The data representative of the GUI design may be maintained in any suitable data format, such as a vector-based, bitmap-based, or other suitable data format.

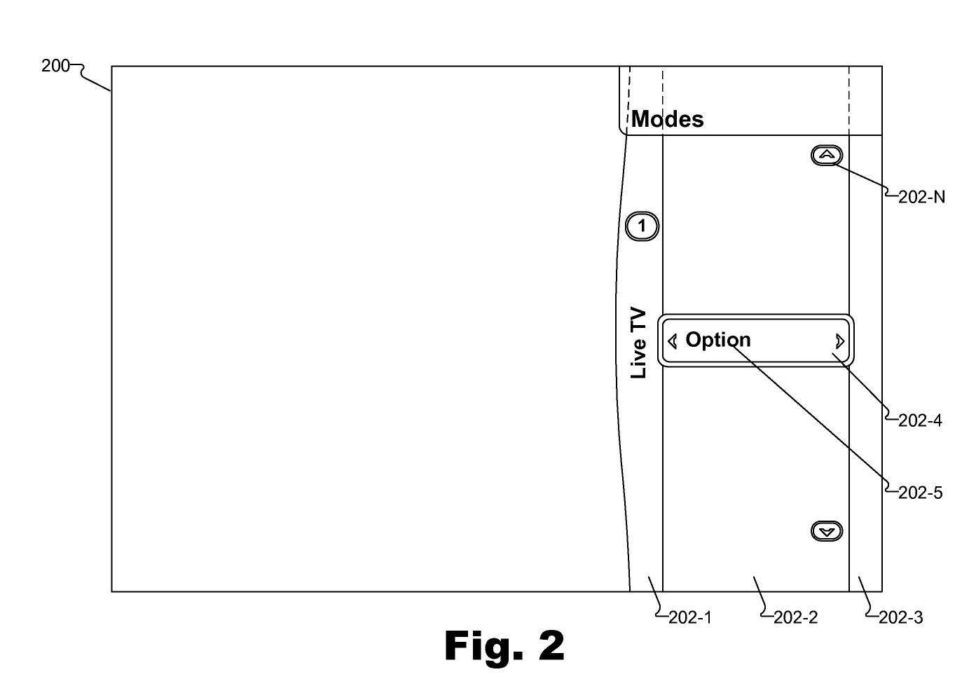

A GUI design may include one or more GUI screen designs, each of which may define a visual layout of one or more graphical elements configured to be displayed within dimensions of a GUI screen in accordance with the visual layout. FIG. 2 illustrates a visual depiction of an exemplary GUI screen design 200 that may be included in a GUI design. As shown, GUI screen design 200 may include one or more graphical elements, such as, but not limited to, graphical elements 202-1 through 202-N, positioned within dimensions of GUI screen design 200 to form a visual layout of the graphical elements. Graphical elements, such as graphical elements 202-1 through 202-N, may be layered in a particular order within GUI screen design 200. In some examples, each graphical element may correspond to a different layer of GUI screen design 200.

A graphical element may include any element that may be visually displayed within a GUI screen. For example, a graphical element may include one or more graphics, text, or a combination of text and one or more graphics that may be displayed within a GUI screen. Examples of graphical elements may include, without limitation, a scroll bar, a navigation arrow, a button, a selector, a selectable menu option, a text string, and any other graphic and/or text.

Design subsystem 104 may be configured to maintain data representative of one or more graphical elements included in a GUI design. Data representative of a graphical element may include an identifier for the graphical element (e.g., an element or layer name), position data indicative of a position of the graphical element within the GUI design (e.g., screen coordinates indicating a position within a GUI screen), pixel data for the graphical element (e.g., pixel data specifying hue, color, saturation, transparency, brightness, and/or other attributes of one or more pixels), text data (e.g., text string, font size, letting information, alignment, and/or other text properties), and any other data descriptive of or otherwise associated with the graphical element. Data representative of graphical elements may further include indicators configured to indicate classes or types of the graphical elements, such as whether graphical elements are header-type, text-type (e.g., graphical elements including text strings), text-only type (e.g., text strings), localizable-type, and/or other types of graphical elements. In certain implementations, such indicators may be included within graphical element identifiers (e.g., within elements or layers names). Such indicators may be provided by a designer of a GUI design and/or generated by design subsystem 104 based on one or more attributes of graphical elements.

In certain examples, class or type indicators may declare one or more graphical elements as being localizable by localization subsystem 102. For example, graphical elements comprising text strings that are able to be translated from one spoken language to one or more spoken languages may be declared to be “localizable” by a designer by including an appropriate indicator in the graphical elements identifiers.

Design subsystem 104 may include an interface through which localization subsystem 102 may interface with design subsystem 104. Any suitable interface may be employed, such as one or more application program interfaces (“APIs”).

Localization subsystem 102 may be configured to interface with design subsystem 104, including interacting with design subsystem 104 to access and/or facilitate processing of design data representative of a GUI design. For example, as described in more detail below, localization subsystem 102 may utilize the accessed design data and/or an interface with design subsystem 104 to localize the GUI design at least by identifying one or more text strings included in the GUI design, facilitating translation of the text strings, and generating, from the translated text strings and the GUI design, one or more additional, localized GUI designs that include the text strings translated into one or more other spoken languages. As used herein, a “spoken language” refers to a human language spoken, written, and/or read by one or more people to communicate with one another and that is capable of being graphically represented in a GUI screen displayed by a display device. Examples of spoken languages include, without limitation, English, Spanish, German, French, Japanese, Chinese, and geographically localized versions thereof (e.g., dialects of a spoken language).

After localization of the GUI design to generate one or more localized versions of the GUI design, localization subsystem 102 may access and use the design data representative of one or more of the GUI designs (e.g., the original GUI design in the first spoken language and one or more localized versions of the GUI design in one or more other spoken languages) to generate and export computing code configured to be processed by one or more target computing devices (e.g., user computing devices) to render one or more GUI screens in accordance with the one or more GUI designs. In some examples, the exported computing code may be configured to be processed by target computing devices to render GUI screens, which may include multiple localized versions of an original GUI screen, that include text strings in different spoken languages. For instance, the rendered GUI screens may include a rendered English language version of GUI screen design 200 shown in FIG. 2, a rendered Chinese language version of GUI screen design 200, and one or more other rendered versions of GUI screen design 200 in one or more other spoken languages.

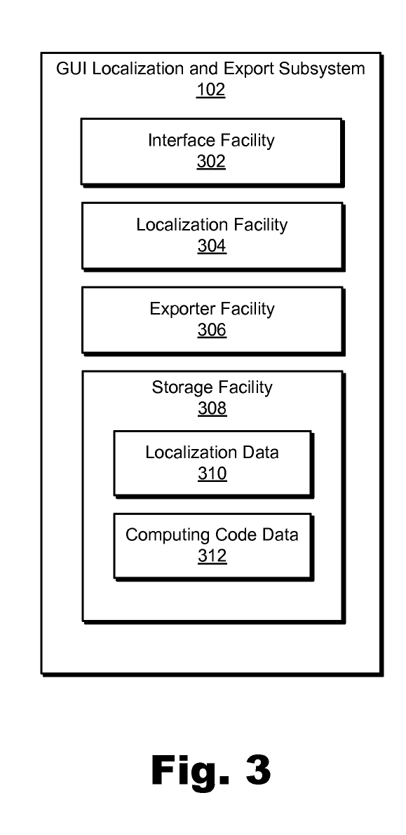

FIG. 3 illustrates exemplary components of localization subsystem 102. As shown, localization subsystem 102 may include, without limitation, an interface facility 302, a localization facility 304, an exporter facility 306, and a storage facility 308, which may be in communication with one another using any suitable communication technologies. It will be recognized that although facilities 302-308 are shown to be separate facilities in FIG. 3, any of facilities 302-308 may be combined into fewer facilities, such as into a single facility, or divided into more facilities as may serve a particular implementation.

Interface facility 302 may be configured to provide an interface through which localization subsystem 102 may interface with design subsystem 104. Interface facility 302 may employ any suitable technologies to provide the interface with design subsystem 104. For example, interface facility 302 may be configured to interface with one or more APIs of design subsystem 104.

Through an interface with design subsystem 104, localization subsystem 102 may access design data representative of a GUI design maintained by design subsystem 104. Additionally or alternatively, through an interface with design subsystem 104, localization subsystem 102 may access and leverage one or more capabilities of design subsystem 104. For example, localization subsystem 102 may instruct design subsystem 104 to perform one or more operations to process design data representative of a GUI design and/or graphical elements included in the GUI design (e.g., to generate and export computing code configured to be processed by target computing devices to render the GUI defined by the GUI design), and/or to generate design data for one or more localized GUI designs of the GUI design. Examples of localization subsystem 102 interfacing with design subsystem 104 are described herein.

Interface facility 302 may be further configured to provide an interface through which localization subsystem 102 may interface with translation subsystem 106. Interface facility 302 may employ any suitable technologies for providing an interface with translation subsystem 106. Through an interface with translation subsystem 106, localization subsystem 102 may provide translation subsystem 106 with one or more data structures (e.g., an Extensible Markup Language (“XML”) file, a data table, a look-up table, a list, etc.) that include one or more text strings in a first spoken language for translation from the first spoken language to one or more other spoken languages and to receive from translation subsystem 106 the one or more data structures including the one or more text strings translated in the one or more other spoken languages. Examples of data structures including text strings are described herein.

Translation subsystem 106 may include any suitable language translation service (e.g., an asynchronous language translation service, a web-based language translation service, etc.), language translation engine, and/or interface to a language translation agency. Translation subsystem 106 may be configured to translate or facilitate translation of text strings from one spoken language to one or more other spoken languages. The translation may be accomplished in any suitable way, including by computer-automated translation, manual translation, facilitation of manual translation by a translation agency, or a combination of automated and manual language translation.

Translation subsystem 106 may include an interface through which localization subsystem 102 may interface with translation subsystem 106. Any suitable interface may be employed, such as one or more application program interfaces (“APIs”). Through the interface, translation subsystem 106 may receive from localization subsystem 102 one or more data structures including one or more text strings in a first spoken language for translation from the first spoken language to one or more other spoken languages. Translation subsystem 106 may translate the one or more text strings from the first spoken language to generate one or more corresponding text strings in one or more other spoken languages (e.g., a second spoken language). Translation subsystem 106 may insert the one or more translated text strings into one or more data structures and provide the one or more data structures to localization subsystem 102, which may receive and process the one or more text strings in the one or more data structures in any of the ways described herein.

Interface facility 302 of localization subsystem 102 may be further configured to provide an interface through which localization subsystem 102 may interface with distribution subsystem 108. Interface facility 302 may employ any suitable technologies for providing an interface with distribution subsystem 108. Through an interface with distribution subsystem 108, localization subsystem 102 may export data, including computing code generated by localization subsystem 102, to distribution subsystem 108 for distribution to and access by a developer.

Interface facility 302 may be further configured to provide an interface through which a user may interact with localization subsystem 102. For example, a user such as a designer may provide user input to localization subsystem 102 through a user interface provided by interface facility 302 to direct localization subsystem 102 to perform one or more of the operations described herein. In certain implementations, for example, execution of one or more of the operations of localization subsystem 102 described herein may be initiated by a user selecting a “localize” option or an “export” option provided in a user interface. In certain implementations, the user interface may provide one or more other selectable options by which a user may select to localize a GUI design to one or more specific spoken languages and/or to export a GUI design in one or more select spoken languages. In some examples, interface facility 302 may be additionally or alternatively configured to provide a proofing user interface for use by a user in proofing localized GUI designs. An example of a proofing user interface is described herein.

In certain implementations, interface facility 302 may be configured to interface with design subsystem 104 to leverage a user interface and/or user interface capabilities native to design subsystem 104. For example, interface facility 302 may instruct design subsystem 104 to display certain content in a user interface of design subsystem 104. The content may be representative of one or more operations performed by localization subsystem 102 such that a designer may be apprised of the status of operations of localization subsystem 102. For instance, the designer may be audibly and/or visually notified when one or more operations of localization subsystem 102 are being performed and/or have completed.

Localization facility 304 may be configured to perform one or more operations to localize a GUI design maintained by design subsystem 104. For example, localization facility 304 may communicate with interface facility 302 to access design data representative of a GUI design and/or to otherwise interface with design subsystem 104. Localization facility 304 may identify, from the design data representative of the GUI design, one or more text strings included in the GUI design in a first spoken language. The text strings may be identified in any suitable way. As an example, localization facility 304 may parse the design data representative of the GUI design to identify one or more attributes indicative of the one or more text strings. Localization facility 304 may be configured to detect any attributes that may be indicative of localizable data such as text strings. As another example, localization facility 304 may identify one or more indicators included in one or more identifiers of one or more graphical elements included in the GUI design. As described above, such indicators, which may be in-line commands within graphical element layer names, may be defined by a designer to declare the one or more graphical elements to be associated with localizable data.

Localization facility 304 may generate and provide translation subsystem 106 with one or more data structures including the one or more text strings in the first spoken language for translation from the first spoken language to one or more other spoken languages, receive from translation subsystem 106 the one or more data structures including the one or more text strings translated into the one or more other spoken languages, and generate, from the one or more translated text strings and the GUI design, one or more additional, localized GUI designs that include the text strings translated into the one or more other spoken languages. In certain implementations, the one or more additional, localized GUI designs may be generated as design data in design subsystem 104. Examples of localization subsystem 102 using design data representative of a GUI design in a first spoken language to generate design data representative of a localized GUI design in a second spoken language are described in detail herein.

In certain implementations, localization facility 304 may be configured to identify potential problems that may be created by translated text strings in a localized GUI design and automatically perform one or more corrective and/or notification operations to correct identified problems and/or notify a designer of the identified problems. For example, localization facility 304 may be configured to detect when a translated text string is too large for the dimensions of a graphical element and automatically modify one or more properties of the translated text string to correct this problem, such as by reducing the font size of the translated text string, wrapping the text of the translated text string, and/or changing any other properties of the text string. As another example, localization facility 304 may be configured to detect when a translated text string is too large for the dimensions of a graphical element and automatically flag the text string and/or a graphical element containing the text string for review by a designer (e.g., using a proofing tool such as described herein) or otherwise provide a notification of the potential program to the designer. The designer may then take appropriate action to correct any problem introduced by the translated text string.

To detect such potential problems in a localized GUI design, localization facility 304 may be configured to analyze properties of the localized GUI design to determine whether a problem such as a text boundary problem may have been introduced by translated text strings. Localization facility 304 may utilize any properties defined in the design data of the localized GUI design to identify such potential problems. For instance, localization facility 304 may compare properties of translated text strings (e.g., text size, number of characters, etc.) to properties of one or more graphical elements associated with the text strings (e.g., boundaries, dimensions, etc.) in order to identify potential problems introduced by translated text strings.

Localization facility 304 may be further configured to provide a proofing tool for use by a designer to proof a localized GUI design generated by localization facility 304. The proofing tool may be configured to perform one or more operations to facilitate proofing of the localized GUI design. For example, the proofing tool may be configured to interface with design subsystem 104 (by way of interface facility 302) to access design data representative of the localized GUI design and provide a user proofing interface that the designer may utilize to view and manually proof one or more graphical elements included in the localized GUI design. The tool may facilitate proofing of the graphical elements such as by displaying all or select graphical elements (e.g., one at a time), or by displaying all graphical screen designs (e.g., one at a time) for viewing and proofing by the designer in a proofing user interface. In certain implementations, for example, the proofing tool may be configured to sequentially open each design file or each selected design file (or each GUI screen or selected GUI screen) within a directory associated with the localized GUI design and provide user input options that allow the designer to provide input to indicate that a graphical element (or GUI screen design) has been approved or to flag a graphical element (or GUI screen design) as having a problem. The tool may further display a counter indicating how many graphical elements (or GUI screen designs) have been proofed and/or await proofing by the designer.

The proofing tool may provide the designer with a convenient and reliable way to manually proof the localized GUI design to ensure that translated text strings fit within the dimensions of graphical elements included in the GUI design. For example, a translated text string in a second language may require more screen space for display that the original text string in a first language. This may lead to the translated text string being too large for the bounds of a graphical object (e.g., a button, a text box, etc.).

In certain implementations, the proofing tool may be configured to select certain graphical elements (or GUI screen designs) to be presented for proofing by the designer. For example, the proofing tool may select only graphical elements (or GUI screen designs) that include translated text strings. As another example, the proofing tool may select only graphical elements (or GUI screen designs) that have been identified by localization facility 304 as potentially including a problem such as a text boundary problem introduced by translated text strings. As another example, the proofing tool may select only graphical elements (or GUI screen designs) that have been automatically corrected by localization subsystem 102 to correct an identified potential problem (e.g., by reducing font size to correct a potential text boundary problem introduced by translated text strings).

Exporter facility 306 may be configured to automatically generate computing code configured to be processed by one or more target computing devices to generate a GUI in accordance with a GUI design. The generation of the computing code may be based on design data maintained by and accessed from design subsystem 104 and that is representative of the GUI design.

As used herein, the term “computing code” may refer to any code that may be processed by a computing device to generate a GUI, such as by rendering a GUI screen for display. As an example, computing code may include computer programming code such as source code, object code, or other executable code. As another example, computing code may include one or more data structures containing data representative of a GUI, wherein the data in the one or more data structures is configured to be parsed by a computing device to generate the GUI. Examples of such data structures may include an XML data structure, a comma-separated value (“CSV”) data structure, and any other data structure that may be parsed by a computing device to generate a GUI.

In certain implementations, exporter facility 306 may generate and export computing code in any of the ways described in co-pending U.S. patent application Ser. No. 12/983,109, filed Dec. 31, 2010, and entitled AUTOMATED GRAPHICAL USER INTERFACE DESIGN AND DEVELOPMENT SYSTEMS AND METHODS, the contents of which are hereby incorporated by reference.

Exporter facility 306 may be configured to generate computing code for localized GUI designs in batch (i.e., as a batch including computing code for all localized versions of a GUI design). For example, exporter facility 306 may generate computing code for all localized versions of a GUI design in batch in response to a detection of a predefined event such as a reception of a “batch export” command from a user or a completion of localization operations for a GUI design. To illustrate, exporter facility 306 may be configured to monitor one or more operations of localization facility 304 and/or conditions related to localized versions of the GUI design (e.g., conditions such as when design data associated with a localized version of the GUI design was last modified, the spoken languages into which text strings included in the GUI design have been translated, the contents of and/or operations performed on one or more localization directory folders, when a localized GUI is approved by a designer through a proofing session, and/or any other suitable conditions). When the monitored operations or conditions satisfy predefined criteria, exporter facility 306 may determine that localization of the GUI design is complete and may automatically generate computing code for the localized versions of the GUI design in batch.

Additionally or alternatively, exporter facility 306 may be configured to generate computing code for select localized GUI designs in response to user input, completion of localization and/or proofing operations, and/or satisfaction of predefined criteria. For example, exporter facility 306 may generate computing code for a localized GUI design in response to user input selecting the localized GUI design for export. As another example, exporter facility 306 may generate computing code for a localized GUI design in response to completion of localization operations associated with the localized GUI design (e.g., in response to creation of the localized GUI design by localization facility 304 or a setting of a proofing status of the localized GUI design to “approved” after a designer has proofed and approved the localized GUI design as described further below).

Exporter facility 306 may be further configured to export data representative of generated computing code and/or other data generated by exporter facility 306 to distribution subsystem 108 for distribution to and access by a developer. The data may be exported to distribution subsystem 108 in any suitable way, including through an interface provided by interface facility 302. In certain implementations, data generated by exporter facility 306 may be automatically exported by localization subsystem 102 to distribution subsystem 108.

Storage facility 308 may be configured to maintain localization data 310 (which may include any data created and/or used by localization facility 304 in relation to localization of a GUI design) and/or computing code data 312 representative of computing code (e.g., any of the computing code described herein). Storage facility 308 may be configured to maintain additional and/or alternative data as may suit a particular implementation.

Returning to FIG. 1, distribution subsystem 108 may be configured to provide a developer with access to computing code and/or any other data exported by localization subsystem 102. Distribution subsystem 108 may be configured to provide the access in any suitable way. For example, distribution subsystem 108 may include one or more staging servers and/or one or more data repositories that may be accessed by a developer. Additionally or alternatively, distribution subsystem 108 may be configured to provide a notification service configured to notify a developer of exported data (e.g., by sending a notification email to the developer).

In certain implementations, distribution subsystem 108 may include a designer repository configured to maintain exported data and a developer repository (e.g., a version control repository) synchronized to include the same data as the designer repository. In such a configuration, localization subsystem 102 may export data to the designer repository, which may store the data and automatically communicate with the developer repository such as by providing one or more updates for use by the developer repository to update data in the developer repository to match the data in the designer repository. In certain examples, the synchronized repositories may be configured to store data in matching directory data structures, which may further automate development of computing code, as described further below.

The data exported by localization subsystem 102 and made available to a developer by distribution subsystem 108 may be in a form that is beneficial to the developer. For example, rather than having to manually produce computing code for a GUI screen based on a GUI design as required in conventional GUI design and development processes, a developer with access to data exported by localization subsystem 102 may conveniently insert, or otherwise make reference to, exported computing code, such as by copying and pasting the pre-generated computing code, into code being produced by the developer or into another appropriate location for processing by a target computing device. This may be done by the developer because the computing code exported by localization subsystem 102 is configured to be processed by a target computing device to render a GUI screen. Consequently, the developer is able to produce code for rendering a GUI screen more efficiently and with fewer opportunities for error when compared to conventional GUI design and development processes.

An exemplary implementation and associated exemplary operations of system 100 will now be described. In an exemplary implementation, design subsystem 104 may include a vector graphics design tool and a bitmap graphics design tool, such as Adobe Illustrator and Adobe Photoshop, for example. Localization subsystem 102 may be configured to interface with the vector and bitmap graphics design tools.

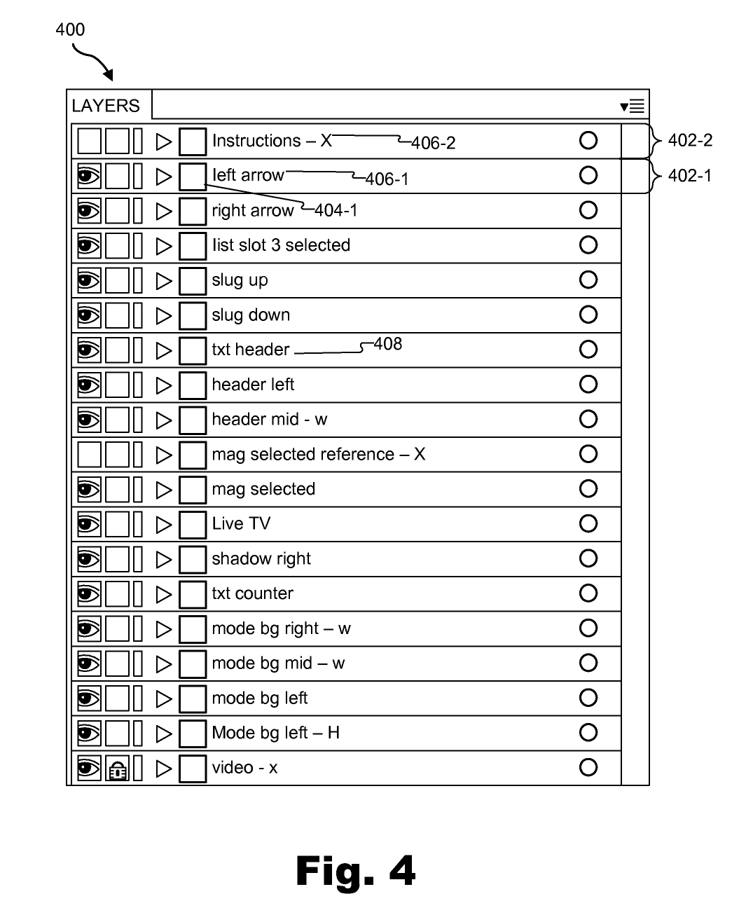

A designer may interact with the vector graphics design tool to define a GUI design. Each graphical element in the GUI design may correspond to a logical construct known as a layer in the GUI design. The vector graphics design tool may maintain and present data representative of the layers included in the GUI design. For example, FIG. 4 illustrates an ordered list 400 of layers associated with GUI screen design 200 shown in FIG. 2, which GUI screen design 200 may be included in the GUI design of the present example. The order of the layers in list 400 may represent an order in which the layers are layered in GUI screen design 200. List 400 may also specify information about the layers. For example, row 402-1 in list 400 may represent a layer corresponding to a particular graphical element included in GUI screen design 200. Row 402-1 may include a thumbnail image 404-1 of the graphical element, a layer name 406-1 (e.g., “left arrow”), and/or any other information related to the graphical element.

A designer may define layer names. In certain examples, localization subsystem 102 may be configured to perform or to refrain from performing one or more operations in response to and/or based on in-line commands included in layer names. Accordingly, a designer who has knowledge of the capabilities of localization subsystem 102 may define layer names to include in-line commands to cause localization subsystem 102 to perform or refrain from performing operations on certain layers. To illustrate, row 402-2 in list 400 may represent a layer corresponding to instructions defined by a designer for use by a developer. A layer name 406-2 for the layer may include an in-line command (e.g., “-X”) that is configured to direct localization subsystem 102 to refrain from performing one or more operations (e.g., rasterizing, exporting, etc.) on the instructions layer. Other in-line commands may be used. For example, in-line commands may be configured to indicate if a graphical element is to be stretched horizontally in width (e.g., a “-w” command) or vertically in height (e.g., a “-H” command). As another example, in-line commands may be employed to indicate a class or type of graphical element associated with a layer, such as whether the graphical element is a text-type, graphics-type, or complex-type (including both text and graphics) graphical element, or whether the graphical element is a button (e.g., “-btn”) type element or another type of element.

Localization subsystem 102 may be configured to detect and utilize in-line commands included in layer names to direct processing of graphical elements, including in any of the ways described herein. For example, as mentioned, localization subsystem 102 may be configured to identify localizable graphical elements included in a GUI design from indicators includes in graphical element identifiers such as indicators included in layer names.

When the designer is finished defining the GUI design in the vector graphics design tool, the designer may provide input, such as a user selection of a localization command presented in a user interface, to initiate processing by localization subsystem 102 to localize the GUI design from the original spoken language associated with the GUI design to one or more other spoken languages. For example, the GUI design may include one or more English text strings, such as a “Modes” text string that may be included in a layer 408 named “txt header” shown in FIG. 4. The “txt” indicator included in the layer name may indicate that layer 408 is or includes a localizable text string. The designer may wish to create a localized version of the GUI design in Spanish and may provide input to localization subsystem 102 to initiate localization of the GUI design from English to Spanish.

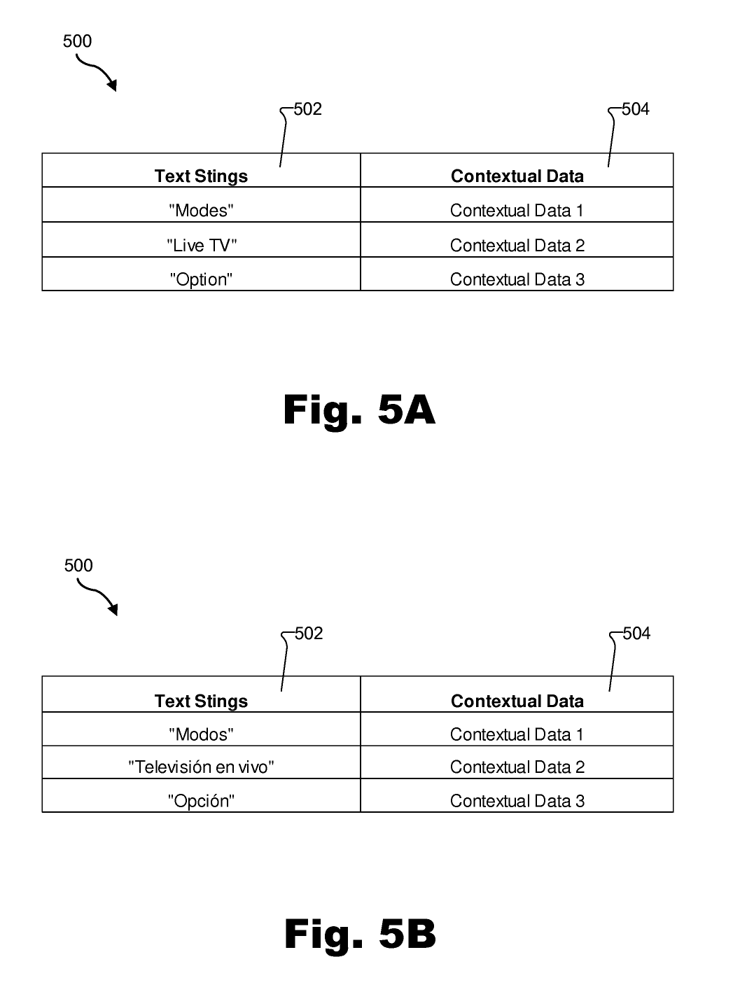

In response to the user input, localization facility 304 may interface with design subsystem 104 to access design data representative the GUI design and identify, from the design data representative of the GUI design, one or more localizable text strings included in the GUI design. Localization subsystem 102 may then generate a data structure that includes data representative of the identified text strings. The data structure may be in any suitable format and may include any data representative of and/or otherwise associated with the text strings. To illustrate, FIG. 5A shows an exemplary data structure in the form of a table 500 generated by localization subsystem 102. As shown, table 500 may include an ordered list 502 of identified text strings included in the GUI design. The order of the text strings in the ordered list 502 may be indicative of positioning of the text strings and/or their corresponding layers in the GUI design.

As further shown in FIG. 5A, table 500 may include contextual data 504 associated with the text strings. Contextual data 504 may include any information associated with the text strings and/or the GUI design. For example, contextual data 504 may include names of layers associated with the text strings, attributes of the layers (e.g., layer classes or types for the layers, graphical element dimensions associated with the layers, etc.), position information indicating positions of the text strings in design data representative of the GUI design, and/or any other information associated with the text strings and/or the GUI design. Contextual data 504 may also include one or more instructions, such as data indicating the original spoken language and one or more target spoken languages into which the text strings are to be translated. Alternatively, such instructions, including data indicating one or more target spoken language into which to translate the text strings, may be generated and provided by localization subsystem 102 to translation subsystem 106 in one or more separate data structures, such as a reference file listing the target spoken languages.

After table 500 is generated, localization subsystem 102 may provide table 500 to translation subsystem 106 for translation of the text strings from English to Spanish. Translation subsystem 106 may receive and process table 500 to translate the text strings in table 500 from English to Spanish and generate a data structure that includes the translated text strings. The data structure may include a new data structure or the same data structure received from localization subsystem 102. For example, translation subsystem 106 may insert the translated text strings into table 500 in place of the English text strings. Contextual data 504 may remain the same or may be updated by translation subsystem 106 to reflect any attributes of the Spanish text strings that are different from attributes of the English text strings (e.g., a number of characters in a text string, etc.).

Translation of text strings may be based at least in part on contextual data 504 included in table 500 received from localization subsystem 102. For example, a layer class or type indicated in contextual data 504 may be used by translation subsystem 106 to determine a translation that best fits the context of the text string. To illustrate, a text string may be included in a button type graphical element. Translation subsystem 106 may use contextual data 504 to determine that the text string is included in a button type graphical element and use this information when selecting a well-suited translation for text that is to be presented in the context of a button in a GUI screen.

FIG. 5B illustrates a data structure in the form of table 500 generated by translation subsystem 106 to be sent from translation subsystem 106 to localization subsystem 102. Table 500 may be modified by translation subsystem 106 to include Spanish text strings in place of English text strings in the ordered list 502 of text strings. The order of the English text strings and the corresponding Spanish translations remains consistent in table 500. That is, the order of the English text strings in table 500 shown in FIG. 5A is maintained for the Spanish text strings in table 500 shown in FIG. 5B. This consistency of list order may be utilized by localization subsystem 102 when using the Spanish text strings to generate a localized Spanish version of the GUI design. For example, the consistent order may be used by localization subsystem 102 to identify positions of the English text strings within the GUI design and to replace the English text strings with corresponding Spanish text strings to create a localized Spanish version of the GUI design.

Localization subsystem 102 may receive, from translation subsystem 106, table 500 shown in FIG. 5B or other suitable data structure containing the Spanish text strings. From the Spanish text strings in table 500 and that GUI design represented in the design data maintained by design subsystem 104, localization subsystem 102 may generate an additional, localized version of the GUI design that includes the Spanish text strings in place of the English text strings.

Localization subsystem 102 may generate the localized Spanish version of the GUI design in any suitable way. For example, localization subsystem 102 may interface with design subsystem 104 to generate additional design data representative of the localized Spanish version of the GUI design in design subsystem 104. The generated design data may represent a copy of the GUI design in which the Spanish text strings are substituted for the English text strings.

The localized Spanish version copy of the GUI design may be generated in any suitable way. In certain implementations, for example, localization subsystem 102 may be configured to generate a duplicate copy of the GUI design and replace the English text strings included in the duplicate copy of the GUI design with the corresponding Spanish translation text strings included in table 500 of FIG. 5B to generate a localized Spanish version of the GUI design. In other implementations, localization subsystem 102 may be configured to perform a “save as” operation to save the GUI design to a new instance and during the “save as” operation replace the English text strings with the corresponding Spanish translation text strings such that the new instance includes the Spanish text strings rather than the English text strings. In other implementations, localization subsystem 102 may be configured to repopulate the GUI design with the Spanish translation text strings, such as by replacing the English text strings in the GUI design with the corresponding Spanish text strings. After the repopulation is complete, localization subsystem 102 may save, or instruct design subsystem 104 to save, a copy of the repopulated GUI design to a new localized Spanish version of the GUI design. The original English version of the GUI design remains accessible in design subsystem 104, and the new localized Spanish version is also accessible by localization subsystem 102 and/or is maintained in design subsystem 104.

As mentioned, in certain examples, localization subsystem 102 may interface with design subsystem 104 to generate the localized Spanish GUI design in design subsystem 104, such that the localized Spanish GUI design is represented by design data maintained by design subsystem 104. To this end, localization subsystem 102 may instruct design subsystem 104 to perform one or more operations to generate the localized Spanish GUI design in any of the ways described herein.

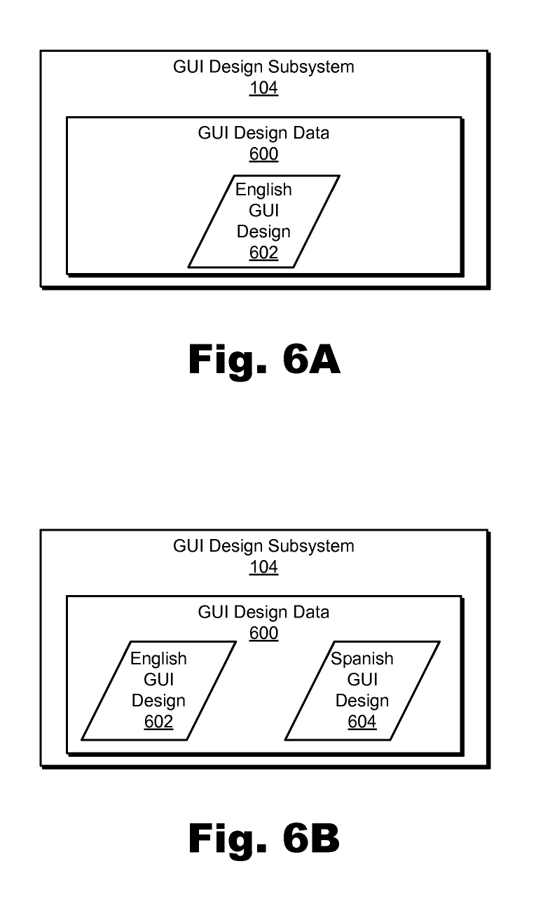

FIG. 6A illustrates a pre-localization state of design data maintained by design subsystem 104. As shown, design subsystem 104 may include GUI design data 600 representative of the original English version of a GUI design 602. FIG. 6B illustrates a post-localization state of design data maintained by design subsystem 104. As shown, design subsystem 104 may now include GUI design data 600 representative of the original English version of GUI design 602 and a localized Spanish GUI design 604, which is a localized Spanish language translation version of GUI design 602 generated by localization subsystem 102 from GUI design 602 and one or more text string translations obtained from translation subsystem 106, as described above.

Localization subsystem 102 may interface with design subsystem 104 to store generated localized versions of GUI designs in any suitable location within design data maintained by design subsystem 104. For example, localization subsystem 102 may cause design subsystem 104 to store localized versions of GUI designs within the same file system directory in which the original GUI design is stored. In some examples, each localized GUI design may be stored within a separate folder in the common directory. As described in more detail herein, exporter facility 306 of localization subsystem 102 may be configured to monitor design data stored within a pre-designated folder or set of folders in order to trigger automatic generation and export of computing code from the design data.

While certain examples described herein are presented in reference to specific spoken languages (e.g., an English GUI design and a localized Spanish GUI design), this is illustrative only. The principles disclosed herein may be implemented to localize a GUI design in a first spoken language to one or more one or more localized versions in one or more other spoken languages. Generation of multiple localized GUI designs may be performed in batch (e.g., in or sequentially by repeating one or more of the localization operations described herein.

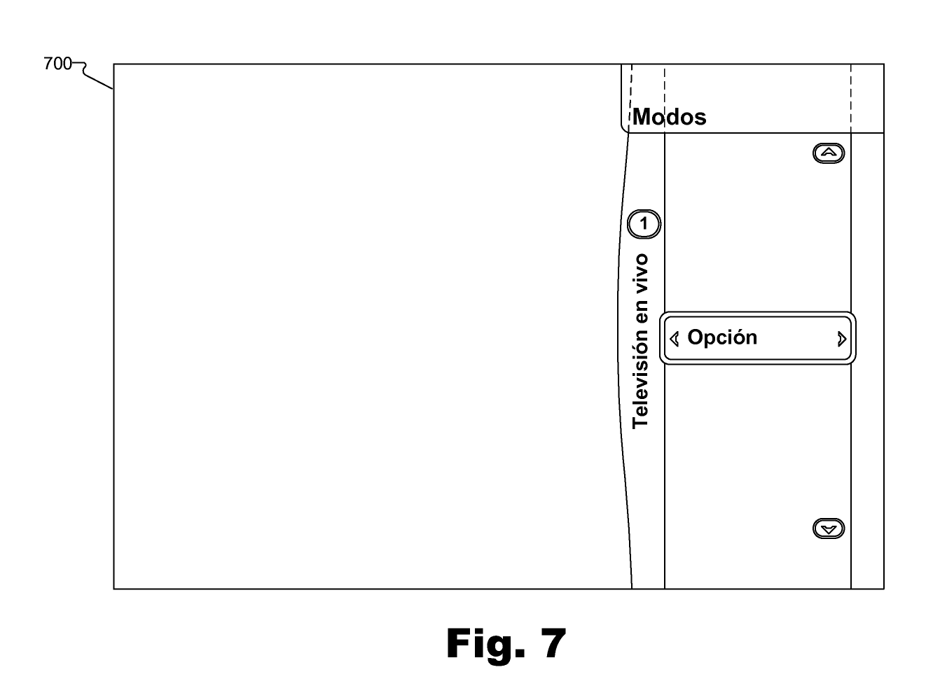

As mentioned, localization subsystem 102 may provide a proofing tool, which a designer may use to proof localized GUI designs generated by localization subsystem 102. For example, the designer may use the proofing tool to proof the localized Spanish GUI design generated by localization subsystem 102 from the original English GUI design as described above. For example, the proofing tool may interface with design subsystem 104 to access design data representative of the localized Spanish GUI design and/or functionality of design subsystem 104 to provide a user interface that the designer may utilize to view and manually proof the localized Spanish GUI design and/or one or more graphical elements included in the localized GUI design. In certain examples, the proofing tool may perform one or more operations that cause a visual depiction of each GUI screen design included in the localized Spanish GUI design to be displayed in a user interface. For instance, FIG. 7 illustrates a visual depiction of an exemplary GUI screen design 700 that may be included in the localized Spanish GUI design. GUI screen design 700 may be a Spanish translation version of GUI screen design 200 shown in FIG. 2. As shown, GUI screen design 700 may include the same graphical elements arranged in the same layout as GUI screen design 200, except that the text strings in GUI screen design 700 are in Spanish instead of English.

The designer may view the displayed GUI screen design 700 and decide whether to approve or not approve the GUI screen design 700. To this end, the proofing tool may provide a user interface including an option that may be selected by the designer to approve the GUI screen design 700 and another option that may be selected by the designer to not approve the GUI screen design 700. If the designer provides input indicating approval of GUI screen design 700, the proofing tool may mark the GUI screen design 700 as approved (e.g., as having a “proofed” or “approved” status). The proofed status may indicate to localization subsystem 102 that GUI screen design 700 is ready for further processing such as generation of computing code from GUI screen design 700 and export of the computing code to distribution subsystem 108.

On the other hand, if the designer provides input indicating that GUI screen design 700 is not approved, the proofing tool may mark the GUI screen design 700 as unapproved (e.g., as having an “un-proofed” or “unapproved” status). The un-proofed status may indicate to localization subsystem 102 that GUI screen design 700 is not yet approved for further processing such as generation of computing code from GUI screen design 700 and export of the computing code to distribution subsystem 108. Localization subsystem 102 may add data representative of the proofed or un-proofed status of GUI screen design 700 and/or any graphical elements included in a GUI design to the design data maintained by design subsystem 104 and/or to data maintained by localization subsystem 102 for use by localization subsystem 102 to determine when to generate and export computing code for a GUI design.

The proofing tool may be used by the designer to step through GUI screen designs included in a localized GUI design. For example, the designer may view a visual depiction of a GUI screen design and either approve or not approve the GUI screen design. In response to the designer's selection, the proofing tool may cause a graphical depiction of a next GUI screen design in the localized GUI design to be displayed for proofing. This may continue until each of the GUI screen designs in the localized GUI design has been presented for proofing. The proofing tool may be similarly used by the designer to step through the graphical elements included in a localized GUI design for a more granular proofing experience.

In some examples, the proofing tool may be configured to sequentially present all GUI screen designs or graphical elements included in a localized GUI design for proofing by the designer. In other examples, the proofing tool may be configured to sequentially present only select GUI screen designs or graphical elements included in a localized GUI design for proofing by the designer, as described above. This may help the designer to efficiently consider only the GUI screen designs or graphical elements potentially affected by localization for proofing after localization of the GUI design.

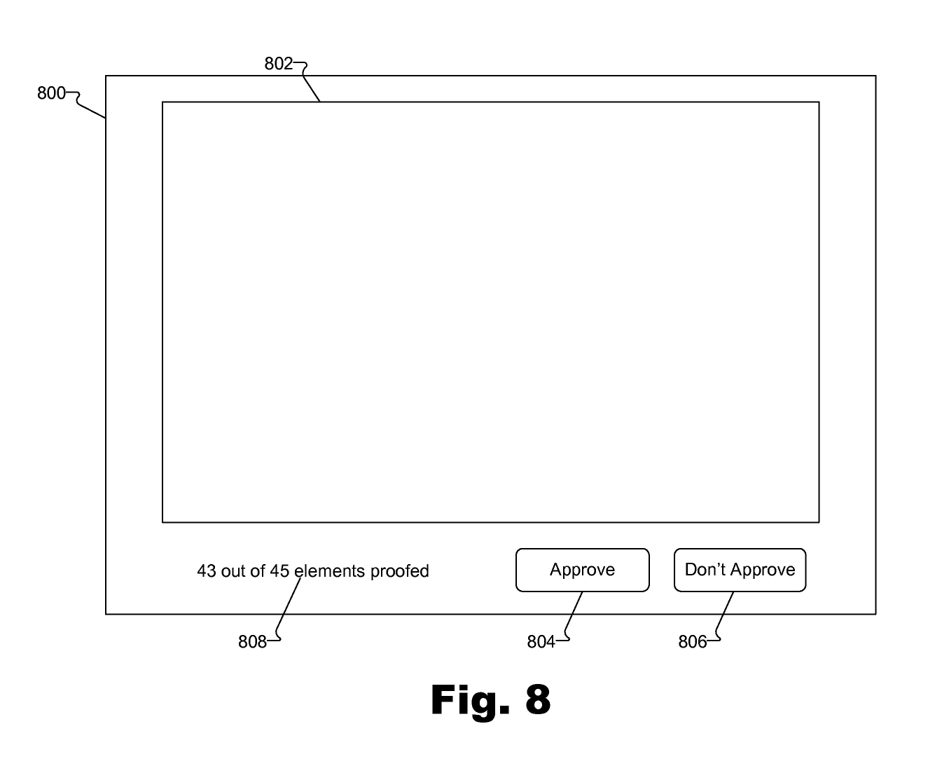

FIG. 8 illustrates an exemplary proofing user interface 800 that may be displayed by or include the proofing tool provided by localization subsystem 102. As shown, proofing user interface 800 may include a display area 802 in which a visual depiction of a GUI screen design or a graphical element included in a localized GUI design may be displayed. Proofing user interface 800 may also include selectable options 804 and 806 that may be selected by a designer to respectively approve or not approve the GUI screen design or graphical element displayed in element display area 802. Proofing user interface 800 may further display a counter 808 indicating a current count of the displayed GUI screen design or graphical element within a total number of GUI screen designs or graphical elements to be presented for proofing in a proofing session.

A designer may interact with design subsystem 104 and/or localization subsystem 102 to modify a localized GUI design to correct any problems identified during a proofing session. For example, the designer may discover that a translated text string is too large for the graphical element (e.g., a button type element) in which the text string is displayed. The designer may interact with design subsystem 104 and/or localization subsystem 102 to modify the text string and/or graphical element to correct the problem. After the correction is made, the designer may approve the graphical element in a proofing session.

After localization of a GUI design to generate one or more localized versions of the GUI design as described above, localization subsystem 102 may interface with design subsystem 104 to generate, from design data representative of the GUI designs, computing code configured to be processed by one or more target computing devices to render GUI screens included in the GUI designs. Localization subsystem 102 may export the computing code to distribution subsystem 108 for access and use by a developer. As mentioned above, localization subsystem 102 may generate and export computing code in any of the ways described in co-pending U.S. patent application Ser. No. 12/983,109, which has been incorporated by reference herein.

As described above, localization subsystem 102 may be configured to generate and export computing code for localized GUI designs in batch (e.g., an entire set or a subset of localized versions of a GUI design) or individually in response to user input, satisfaction of predefined conditions, or other suitable trigger. In some implementations, for example, localization subsystem 102 may be configured to monitor a localization folder within design data maintained by design subsystems 104 to determine when localization of a GUI design is completed and the localized GUI designs ready to be used for generation and export of computing code configured for processing by a target computing device to render one or more GUI screens defined by the GUI design. The monitoring may monitor any attributes of the folder and/or its contents. For example, localization subsystem 102 may monitor the content of the folder to determine when all files associated with a localization of a GUI design are included in the folder, modification dates associated with the folder and/or its contents, and/or any other attributes of the folder and/or its contents.

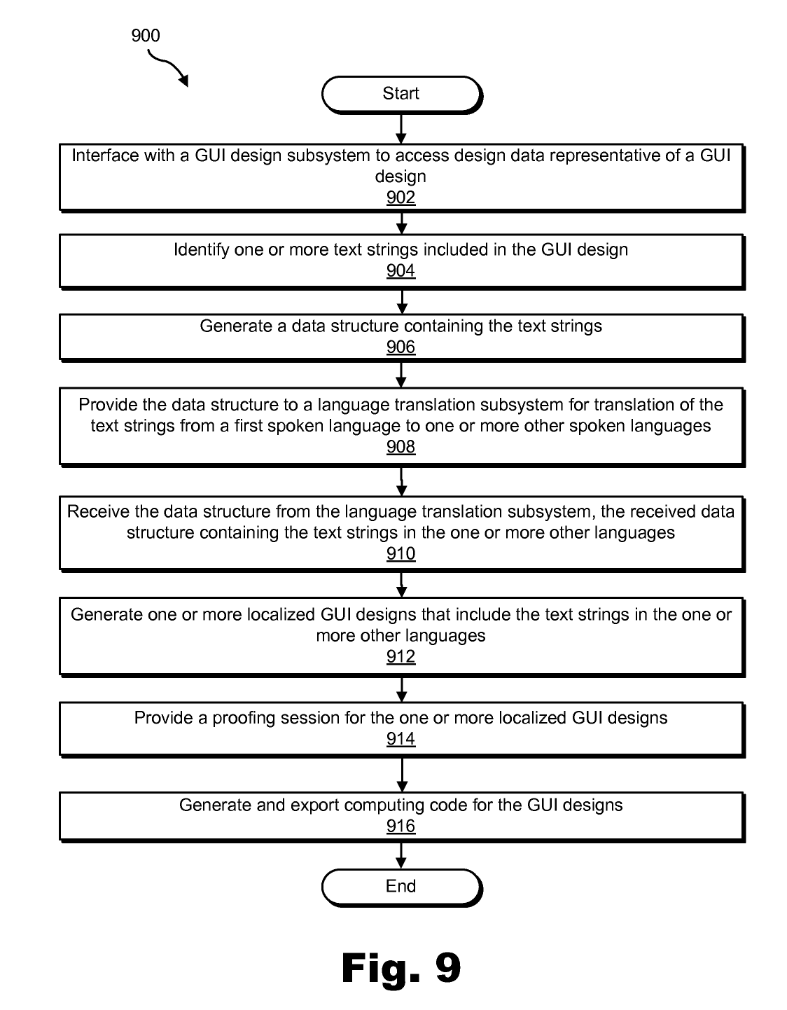

FIG. 9 illustrates an exemplary automated GUI localization method 900. While FIG. 9 illustrates exemplary steps according to certain embodiments, other embodiments may omit, add to, reorder, combine, and/or modify any of the steps shown in FIG. 9. The steps shown in FIG. 9 may be performed by localization subsystem 102 and/or any other component(s) of system 100.

In step 902, localization subsystem 102 may interface with a GUI design subsystem such as design subsystem 104. The interfacing may include accessing design data representative of a GUI design and/or leveraging one or more capabilities of the GUI design subsystem, as described herein.

In step 904, localization subsystem 102 may identify, from the design data, one or more text strings included in the GUI design. The one or more text strings may be in a first spoken language. Step 904 may be performed in any of the ways described herein.

In step 906, localization subsystem 102 may generate a data structure containing data representative of the text strings in the first spoken language. The data structure may include any suitable data structure, including any of those described herein. The data structure may include additional data such as contextual data and/or instructions for use by a language translation subsystem, as described herein.

In step 908, localization subsystem 102 may provide the data structure to a language translation subsystem (e.g., translation subsystem 106) for translation of the text strings from the first spoken language to one or more other spoken languages. Step 908 may be performed in any of the ways described herein.

In step 910, localization subsystem 102 may receive the data structure from the language translation subsystem. The received data structure may include any suitable data structure, including the same data structure provided to the language translation subsystem by localization subsystem 102, a copy of the data structure provided to the language translation subsystem by localization subsystem 102, or a new data structure generated by the language translation subsystem. The received data structure may contain data representative of the text strings in the one or more other spoken languages.

In step 912, localization subsystem 102 may generate one or more localized GUI designs that include the text strings in the one or more respective spoken languages. The localized GUI designs are localized versions of the GUI design that includes the text strings in the first spoken language. Step 912 may be performed in any of the ways described herein.

In step 914, localization subsystem 102 may provide a proofing session for the one or more localized GUI designs. The proofing session may be configured to facilitate a user such as a designer of the GUI design proofing the localized GUI designs. Step 914 may be performed in any of the ways described above, including by localization subsystem 102 providing a proofing tool (e.g., by presenting a proofing user interface) for use by a designer to proof elements of the localized GUI designs (e.g., by the designer visually inspecting one or more GUI screen designs and/or graphical elements of the localized GUI designs), as described herein.

In step 916, localization subsystem 102 may generate and export computing code for the GUI designs. For example, localization subsystem 102 may generate, from the GUI designs (e.g., the original GUI design and the one or more localized GUI designs), computing code configured to be processed by one or more target computing devices to render GUI screens included in the GUI designs. Localization subsystem 102 may export the computing code to distribution subsystem 104, as described herein.

In certain embodiments, one or more of the components (e.g., localization subsystem 102 and/or other components of system 100) and/or processes described herein may be implemented and/or performed by one or more appropriately configured computing devices. To this end, one or more of the systems and/or components described above may include or be implemented by any computer hardware and/or computer-implemented instructions (e.g., software), or combinations of computer-implemented instructions and hardware, configured to perform one or more of the processes described herein. In particular, system components may be implemented on one physical computing device or may be implemented on more than one physical computing device. Accordingly, system components may include any number of computing devices, and may employ any of a number of computer operating systems.

One or more of the processes described herein may be implemented at least in part as instructions executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein, as directed by the instructions. Such instructions may be stored in any suitable computer-readable medium.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other medium from which a computer can read.

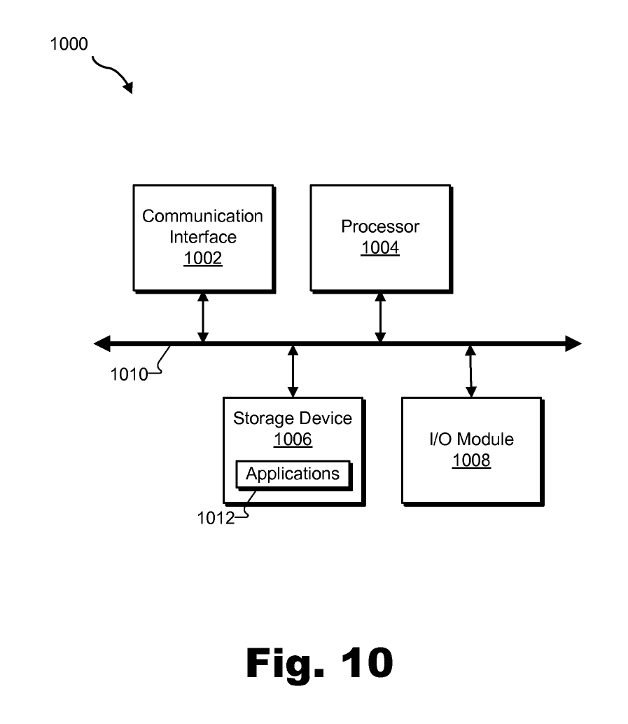

FIG. 10 illustrates an exemplary computing device 1000 configured to perform one or more of the processes described herein. In certain embodiments, computing device 1000 may implement localization subsystem 102 and/or one or more other components of system 100. As shown in FIG. 10, computing device 1000 may include a communication interface 1002, a processor 1004, a storage device 1006, and an input/output (“I/O”) module 1008 communicatively connected via a communication infrastructure 1010. While an exemplary computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, and any other suitable interface. Communication interface 1002 may additionally or alternatively provide such a connection through, for example, a local area network (such as an Ethernet network), a personal area network, a telephone or cable network, a satellite data connection, a dedicated URL, or any other suitable connection. Communication interface 1002 may be configured to interface with any suitable communication media, protocols, and formats, including any of those mentioned above.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1006. For example, data representative of one or more executable applications 1012 configured to direct processor 1004 to perform any of the operations described herein may be stored within storage device 1006. In some examples, data may be arranged in one or more databases residing within storage device 1006.

I/O module 1008 may be configured to receive user input and provide user output and may include any hardware, firmware, software, or combination thereof supportive of input and output capabilities. For example, I/O module 1008 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1008 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1008 is configured to provide graphical data to a display for presentation to a user. The graphical data may be representative of one or more GUIs and/or any other graphical content as may serve a particular implementation.

In certain implementations, one or more facilities of localization subsystem 102 may be implemented by computing device 1000. For example, applications 1012 may be configured to direct processor 1004 to perform one or more operations of interface facility 302, localization facility 304, and/or exporter facility 306. Additionally or alternatively, storage facility 308 may be implemented on storage device 1006.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
interfacing, by a graphical user interface localization subsystem, with a graphical user interface design subsystem to access design data representative of a graphical user interface design that includes one or more text strings in a first spoken language;
identifying, by the graphical user interface localization subsystem from the design data, the one or more text strings in the first spoken language included in the graphical user interface design;
generating, by the graphical user interface localization subsystem, a data structure containing data representative of the one or more text strings in the first spoken language;
providing, by the graphical user interface localization subsystem, the data structure to a language translation subsystem for translation of the one or more text strings from the first spoken language to a second spoken language;
receiving, by the graphical user interface localization subsystem, the data structure from the language translation subsystem, the received data structure containing data representative of the one or more text strings in the second spoken language; and
generating, by the graphical user interface localization subsystem from the received data structure and the design data representative of the graphical user interface design, a localized version of the graphical user interface design that includes the one or more text strings in the second spoken language.

2. The method of claim 1, wherein the generating of the localized version of the graphical user interface design comprises interfacing with the graphical user interface design subsystem to generate additional design data representative of the localized version of the graphical user interface design.

3. The method of claim 1, wherein the generating of the localized version of the graphical user interface design comprises interfacing with the graphical user interface design subsystem to generate design data representative of a copy of the graphical user interface design in which the one or more text strings in the second spoken language are substituted for the one or more text strings in the first spoken language.

4. The method of claim 1, wherein the identifying of the one or more text strings comprises parsing the design data to identify one or more attributes indicative of the one or more text strings.

5. The method of claim 1, wherein the identifying of the one or more text strings comprises identifying one or more indicators included in one or more identifiers of one or more graphical elements included in the graphical user interface design, the one or more indicators configured to declare the one or more graphical elements to be associated with localizable data.

6. The method of claim 1, wherein:
the generated data structure comprises an ordered list of the one or more text strings in the first spoken language;
the received data structure comprises an ordered list of the one or more text strings in the second spoken language; and
an order of the one or more text strings in the first spoken language in the ordered list in the generated data structure is maintained for the one more text strings in the second spoken language in the ordered list in the received data structure.

7. The method of claim 6, wherein the generating of the localized version of the graphical user interface design comprises using the maintained order of the one more text strings in the second spoken language in the received data structure to substitute the one or more text strings in the second spoken language for the one or more text strings in the first spoken language in a copy of the graphical user interface design.

8. The method of claim 1, further comprising providing, by the graphical user interface localization subsystem, a proofing session configured to facilitate a user proofing the localized version of the graphical user interface design.

9. The method of claim 8, wherein the providing of the proofing session comprises:
presenting a proofing user interface configured to display one or more graphical elements included in the localized version of the graphical user interface design for visual inspection by the user; and
providing selectable options in the proofing user interface for selection by the user to approve or not approve the one or more graphical elements included in the localized version of the graphical user interface design.

10. The method of claim 1, further comprising:
generating, by the graphical user interface localization subsystem, computing code configured to be processed by a target computing device to render one or more graphical user interface screens in accordance with the localized version of the graphical user interface design; and
exporting, by the graphical user interface localization subsystem, the computing code to a graphical user interface distribution subsystem for access by a developer.

11. The method of claim 10, wherein the computing code for the localized version of the graphical user interface design is generated and exported as a batch together with computing code for one or more additional localized versions of the graphical user interface design.

12. The method of claim 10, wherein the generating and the exporting are performed automatically in response to a detected condition of the localized version of the graphical user interface design.

13. The method of claim 1, wherein the generating of the localized version of the graphical user interface design comprises automatically modifying one or more properties of the text strings in the second spoken language in the localized version of the graphical user interface design.

14. The method of claim 1, embodied as computer-executable instructions on at least one non-transitory computer-readable medium.

15. A method comprising:
Identifying, by a graphical user interface localization subsystem, one or more text strings in a first spoken language included in a graphical user interface design;
generating, by the graphical user interface localization subsystem, a data structure containing data representative of the one or more text strings in the first spoken language;
providing, by the graphical user interface localization subsystem, the data structure to a language translation subsystem for translation of the one or more text strings from the first spoken language to a second spoken language;
receiving, by the graphical user interface localization subsystem, the data structure from the language translation subsystem, the received data structure containing data representative of the one or more text strings in the second spoken language; and
generating, by the graphical user interface localization subsystem based on the received data structure and the graphical user interface design, a localized version of the graphical user interface design that includes the one or more text strings in the second spoken language.

16. The method of claim 15, embodied as computer-executable instructions on at least one non-transitory computer-readable medium.

17. A system comprising:
at least one processor; and
a localization facility configured to direct the at least one processor to:
identify, from design data maintained by a graphical user interface design subsystem and representative of a graphical user interface design, one or more text strings in a first spoken language included in the graphical user interface design,
generate a data structure containing data representative of the one or more text strings in the first spoken language,
provide the data structure to a language translation subsystem for translation of the one or more text strings from the first spoken language to a second spoken language,
receive the data structure from the language translation subsystem, the received data structure containing data representative of the one or more text strings in the second spoken language, and
generate, from the received data structure and the design data representative of the graphical user interface design, a localized version of the graphical user interface design that includes the one or more text strings in the second spoken language.

18. The system of claim 17, wherein the localization facility is configured to direct the at least one processor to identify the one or more text strings by parsing the design data to identify one or more attributes indicative of the one or more text strings.

19. The system of claim 17, wherein the localization facility is configured to direct the at least one processor to identify the one or more text strings by identifying one or more indicators included in one or more identifiers of one or more graphical elements included in the graphical user interface design, the one or more indicators configured to declare the one or more graphical elements to be associated with localizable data.

20. The system of claim 17, wherein:
the generated data structure comprises an ordered list of the one or more text strings in the first spoken language;
the received data structure comprises an ordered list of the one or more text strings in the second spoken language; and
an order of the one or more text strings in the first spoken language in the ordered list in the generated data structure is maintained for the one more text strings in the second spoken language in the ordered list in the received data structure.

21. The system of claim 20, wherein the localization facility is configured to direct the at least one processor to generate the localized version of the graphical user interface design by using the maintained order of the one more text strings in the second spoken language in the received data structure to substitute the one or more text strings in the second spoken language for the one or more text strings in the first spoken language in a copy of the graphical user interface design.

22. The system of claim 17, further comprising:
an exporter facility configured to direct the at least one processor to:
generate computing code configured to be processed by a target computing device to render one or more graphical user interface screens in accordance with the localized version of the graphical user interface design, and
export the computing code to a graphical user interface distribution subsystem for access by a developer.
